(19) United States
(12) Patent Application Publication
(10) Pub. No.: US 2008/0256565 A1
(43) Pub. Date: Oct. 16, 2008

(54) DISC TRANSPORT AND METHOD OF DISC REMOVAL

(75) Inventors: Dale K. Kubin, Murrieta, CA (US); Nathan P. Scherdin, Poway, CA (US)

Correspondence Address: DOBRUSIN & THENNISCH PC, 29 W LAWRENCE ST, SUITE 210, PONTIAC, MI, 48342, US

(73) Assignee: XLNT IDEA, INC.

(21) Appl. No.: 12/049,605

(22) Filed: Mar. 17, 2008

Related U.S. Application Data
(60) Provisional application No. 60/895,169, filed on Mar. 16, 2007.

(51) Int. Cl. G11B 17/04

(52) U.S. Cl. 720/619

(57) ABSTRACT

An apparatus for disc publishing comprising a disc transport movable along a first slide member, the disc transport including: an engagement mechanism for selective engagement of at least one disc, a print assembly for printing to the at least one disc, the print assembly including one or more print heads movable along a second slide member; and a print tray adapted to receive the at least one disc from the disc transport; a recording device for recording to the at least one disc, the recording device including a recording tray adapted to receive and record to the at least one disc from the disc transport; a disc supply receptacle adapted to receive one or more discs, the disc supply receptacle being positioned below and in alignment along an engagement axis with the engagement mechanism for selective engagement of the at least one disc; and a control unit adapted to control the functions of the disc publishing device; wherein the disc transport and the one or more prints heads are adapted to move independent of each other wherein the print tray and the recording tray have an open position that is in alignment along the engagement axis for selective engagement of the at least one disc by the engagement mechanism.

### CLAIM OF PRIORITY

The present invention claims the benefit of the filing date of U.S. Provisional Application Ser. No. 60/895,169, filed Mar. 16, 2007, which is incorporated herein by reference for all purposes.

### TECHNICAL FIELD

The field of the present invention relates to disc-publishing devices and more particularly to disc-publishing devices adapted to print to a plurality of discs and optionally record to them.

### BACKGROUND ON THE INVENTION

Media device manufacturers currently provide consumers with disc publishing devices configured for processing media (such as storage discs, or otherwise). Such processing includes printing, recording, or otherwise using media components that are typically separate from one another, which requires the use of a transport mechanism for movement of storage media to components of the publishing devices for processing therein. Recently, media device manufacturers have attempted to combine the features into a single disc-publishing device for both transporting and processing media.

However, the disc publishing devices have failed to provide an efficient user-friendly compact disc-publishing device. As an example, in order for these disc-publishing devices to mass-produce multiple processed discs with limited user interaction, they require the use additional media components and a disc transport mechanism with more than one axis of movement to these additional media components. These additional components occupy large spaces that require multiple media components and media storage sites for processing of media discs. As such, if the user wishes to process multiple discs on a smaller scale, the user must use the typically large and costly disc-publishing devices.

Accordingly, at a minimum, there is a need for a more efficient and compact disc-publishing device capable of printing and recording to multiple media. In addition, there is a need for reducing manufacturing costs for producing such compact disc publishing devices capable of processing media with minimal user interaction.

### SUMMARY OF THE INVENTION

The present invention overcomes the drawbacks of the prior art by providing a disc publishing device having an improved design, which provides more efficient operation and orientation of the device's components for the handling and use of disc media. Advantageously, this new design further provides an economically priced disc publishing device, which is advantageously sized for an individual use, small business, or otherwise, and which is more user friendly than prior art disc publishing devices.

In one aspect, the present invention meets the above needs by providing a disc publishing device having a disc transport robot that is moveable in generally one direction, which is in alignment with the multiple disc engagement points along a single axis, thereby making the disc publishing device more accessible to an end user. The arrangement of the engagement mechanism of the disc transport having aligned points of engagement in a generally vertical axis with the media components (e.g., printer assembly and recording device) and the single disc receptacle allows for a very compact disc publishing device.

In another aspect, the present invention provides for a disc removal feature for removing processed discs or failure discs from the disc publishing device. As such, the present invention provides a method for removing storage discs directed to smaller, compact component arrangement for disc printing and duplication.

### BRIEF DESCRIPTION OF THE DRAWINGS

FIG. 1 illustrates a side view of one embodiment of the present invention.

FIG. 2 illustrates a perspective view of another embodiment of the present invention.

FIG. 3 illustrates another perspective view of the present invention.

FIG. 4 illustrates another perspective view of the present invention.

FIG. 5 illustrates another perspective view of the present invention.

FIG. 6 illustrates another perspective view of the present invention.

### DETAILED DESCRIPTION OF THE INVENTION

The present invention provides a compact disc-publishing device for processing storage devices, including, but not limited to: compact discs, digital video discs, mini discs, the like, combinations thereof or otherwise. Advantageously, the device may be adapted to provide one or more media components for processing a disc by way of printing and/or recording to a disc. The processed disc may be then extracted from the respective media tray, which preferably is separate in operation to that of a disc transport (e.g., the transportation mechanism and movable tray mechanism are not movably attached) as disclosed in U.S. application Ser. No. 11/335,381 entitled “Printer” is herein incorporated by reference for all purposes. Accordingly, the device may be adapted to simultaneously perform multiple tasks (e.g., printing to a first disc while transporting a second disc or otherwise). This separation of operation provides more efficient functioning of the device resulting in faster printing capabilities and other advantageous features as implicitly or explicitly disclosed herein.

Referring to the drawings, exemplary embodiments and features of the present invention are shown. The present invention provides a disc-publishing device 10 for copying, printing, and/or recording of one or more storage devices, such as disc 12. The device includes a housing (not shown) adapted to provide support and enclosure for one or more of the components of the device. Preferably, the housing may be relatively small such that it can be placed upon a desktop or the like.

The disc-publishing device includes a disc transport 16 adapted to engage and move one or more discs, preferably one at a time. The disc transport may be movably mounted to a first slide member 18, which extends generally vertically from the housing and is mounted or otherwise secured thereto. Advantageously, this movement allows the engagement mechanism 20 of the disc transport to be lowered over a disc for engagement thereof. Subsequently, the disc may be lifted away from a disc supply receptacle 50, to a desired location, thereabove. Upon arrival to the desired location (e.g., a print location, record location, final destination or otherwise), the disc may be lowered to a predetermined height and released for further processing of the disc or otherwise. The disc publishing device may be configured for multiple disc engagement points along an engagement axis 14 that may be generally vertical and parallel to the first slide member. As such, the media components (e.g., printer, recording device, disc receptacle, or otherwise and any combination thereof) may be positioned relative to the engagement axis and may be adapted for receiving storage discs therefrom.

For example, the disc-publishing device may be configured with a disc supply receptacle 50 that may be adapted to receive and hold discs for processing. The disc supply receptacle may be positioned in alignment with the engagement axis and the engagement mechanism of the disc transport located thereabove. A single supply receptacle further reduces the size of the disc publishing device, while possibly minimizing manufacturing costs. In a preferred embodiment, the disc supply receptacle may be fixedly secured to the housing of the disc publishing device; however it is appreciated that the disc supply receptacle may be removable. The disc supply receptacle preferably may be adapted to hold at least 10 discs, more preferably at least 25 discs, and even more preferably at least 50 discs.

The mounting of the disc transport to the first slide member provides slidable movement of the disc transport along the first slide member such that a disc may be moved substantially along the generally parallel path of the engagement axis. Accordingly, preferably the disc transport may be configured with the disc engagement mechanism 20, which is adapted to attach to a portion of a disc, and preferably in a disc hole formed therein, for subsequent movement of the disc along the engagement axis.

As previously mentioned, the disc transport may be adapted to move along a substantial portion of the first slide member. Accordingly, the device further includes drive means linkably attached to the disc transport, via a linkage or otherwise, to provide a suitable force to move the disc transport to various points along the first slide member. Suitable drive member may include, but are not limited to, a stepper motor or other suitable drive members used for moving a printer component along a bearing surface or the like. Suitable linkages include, but are not limited to, belts, cables, chains, screws, the like or otherwise. In a preferred embodiment, the linking mechanism comprises a belt. However, it should be appreciated that numerous types of drive assemblies and linkages are available and may be used, as are commonly utilized in the design of inkjet printers.

The first slide member 18 may comprise of any member adapted to guide an attached member along a portion of its length, width or otherwise. Suitable guiding feature include tracks, shafts, rails, grooves, the like or otherwise. Suitable elongated members include shafts, rods, beams, rails, the like or otherwise.

The disc transport includes a disc engagement mechanism 20 adapted to selectively engage a disc portion. The engagement mechanism may include engagement fingers, which when combined form a diameter that generally corresponds to the disc hole formed in the disc 12 and may be adapted to move relative to each other. By way of example, in a first position, the fingers may be in a closed position such that the resulting diameter of the fingers may be less than the diameter of the disc hole. Accordingly, the fingers can move into the disc hole without substantial interference. In a second position, the fingers my be separate so as to form a diameter that may be equal to, or greater than the diameter of the disc hole such that the fingers engage the inner walls of the disc hole to prevent the disc from disengaging from the disc engagement mechanism. It should be appreciated that the fingers may engage the interior walls of the disc hole and optionally form a friction fit through an application of i) pressure by the fingers, ii) support the disc from its underside using flanges on one or both fingers, or otherwise and combinations thereof. Optionally, the one or more of the engagement fingers may include a tapered end portion for assisting in the alignment and insertion of the fingers into the disc hole.

In view of the foregoing, it should be appreciated that upon engagement with a disc (e.g., movement of the fingers from a first position to a second position) the disc is moved along the first slide member to a different engagement point along the engagement axis of the disc publishing device 10. Accordingly, when the disc transport reaches a desired engagement point location, the engagement fingers move back to the first position, thereby resulting in the disengagement of the disc from the engagement mechanism.

The disc transport may be further configured with one or more additional features, such as a disc removal feature, for assisting in the removal of processed discs from the disc publishing device. In one preferred embodiment, the device further comprises a method for removing a processed disc. A movable tray from a media component (e.g., a printer assembly, a recording device, or otherwise and combinations thereof and the disc transport provide a means for removing processed discs from the disc publishing device. The disc removal feature enables the operator of the disc publishing device external access to the processed discs. A processed disc or a failure disc may be then removed from the disc publishing device and subsequently placed at a disc storage area. Accordingly, a user may place or replace a plurality of blank disc at the disc supply receptacle within the disc publishing device. Furthermore, the user may retrieve completed discs (e.g., recorded and/or labeled discs) at the storage area, which may be located outside of the disc publishing device housing. Access to the disc supply receptacle, the storage area, or both may be achieved without substantial interruption of the operation of the disc publishing device.

In one aspect, the disc removal feature comprises a stop flange 24 that downwardly extends from the disc transport and may be located approximate to (e.g., separate from) the engagement mechanism. Optionally, or as an alternative, the disc removal feature may be integrated with the engagement mechanism utilizing the engagement fingers for disc removal. Preferably, the disc removal feature has a generally flat front portion that extends downward from a lower surface of the disc transport. When positioned proximate to an outer edge portion of a disc that is partially disposed on a movable tray, (e.g., printer tray, recording tray, or otherwise), the disc removal feature prevents the partially disposed disc from moving relative to the movement of the retracting movable tray, as discussed below.

Advantageously, the disc transport may further comprise one or more sensors for determining when the engagement mechanism may be in a proper (e.g., predetermined) location for engaging or releasing a disc. Suitable sensors include pressure sensor, optical sensors, electro mechanical sensors, Hall Effect sensors or otherwise. In one aspect, it is contemplated that the sensor may be located on or associated with the flanges extending from the fingers of the engagement mechanism. The sensors determine when the engagement mechanism may be flush with the disc (e.g., partially disposed within the disc hole) so that upon separation of the engagement fingers, the engagement mechanism will engage the disc. In another aspect the disc transport may include a sensor. Preferably, the stop flange 24 of the disc transport may include an integrated sensor for determining the position of the stop flange 24 with respect to the movable tray of a media component, the supply receptacle, or otherwise.

In view of the forgoing, the present invention may be further adapted to perform multiple tasks to create a final disc product. Of these tasks, one particularly useful task includes recording information to the disc for subsequent retrieval. Such information may include music, videos, files, or other types commonly recorded through optical means. Accordingly, in a preferred embodiment, the disc-publishing device further includes a digital recording device 34 adapted to record information to a disc. The recording device may be configured to receive a disc from the disc transport, subsequently record information to the disc and make the disc available to the disc transport for subsequent tasks or otherwise. It should be appreciated that the information to be recorded to the disc may originated from another component, input port, as described herein, or otherwise.

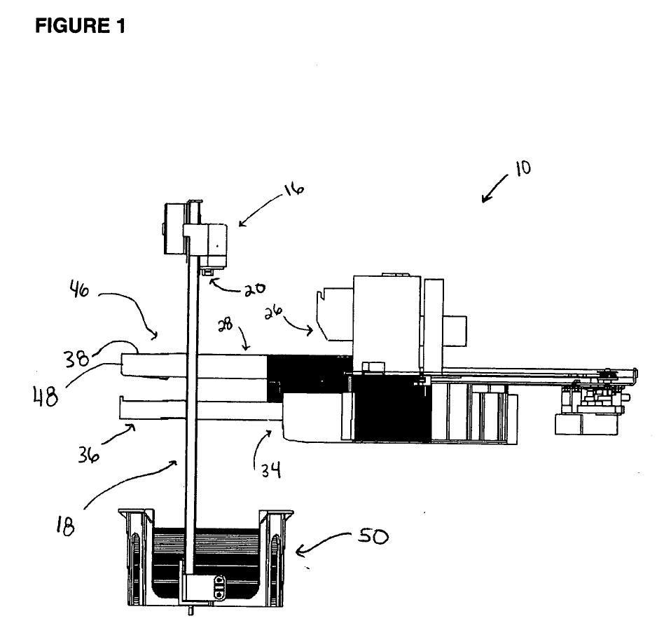

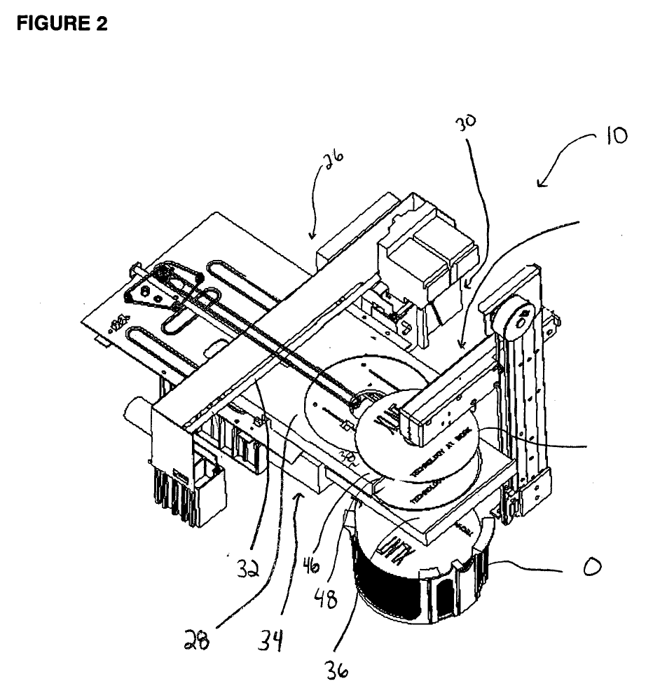

Referring to FIGS. 1-2, a suitable disc-recording device, for recording digital information to a disc, is illustrated. The recording device may be mounted to the housing and preferably located adjacent to the print assembly. The recording device further includes a recording tray 36 that extends perpendicularly the first slide member. In this exemplary embodiment, the tray may be adapted to reside in a first retracted position, wherein information may be recorded, and extend to a second position for receiving and/or providing a disc to the engagement mechanism. It should be appreciated that movement of the tray may be achieved using common techniques used in compact disc and digital video disc players and recording devices, or otherwise.

In operation, the recording device extends the tray to an extended position for receiving a disc from the disc transport. Similar to the movement of the print tray, if not already located there, the recording tray moves to a position substantially in alignment with the engaged disc overhead. The disc transport lowers the disc into the recording tray and releases the disc. The disc transport then moves away from the recording tray and the recording tray may be retracted to the first position for recording. Upon completion of recording to the disc, the recording tray extends to an extended position so that the center portion of the recording tray, more specifically, the hole of the disc within, may be in general alignment along the engagement axis and with the engagement mechanism of the disc transport, thereabove. The disc transport can retrieve the disc for further processing or otherwise. Advantageously, the recording device, more specifically, the recording tray may include calibration means to align the same with the engagement axis, the engagement mechanism, thereabove, or both.

Another useful task that may be performed with the present invention includes printing a design, text or otherwise to a disc for identification purposes, or otherwise. Accordingly, the disc-publishing device may further include a print assembly 26 adapted to print to a disc using common printing techniques (e.g., inkjet laser or otherwise). In a preferred embodiment, the print assembly includes one or more print head 30 and ink cartridges having colors commonly associated with inkjet printing (e.g., black, white, reds, blues, greens, combinations there of as otherwise). The print heads are mounted to a second slide member 32, which preferably extends along at least a portion of the housing and may be mounted or otherwise secured thereto. It should be appreciated that the second slide member may include any of the features of the first slide member. The mounting of the print assembly to the second slide member provides movement along a second slide member axis, which preferably may be substantially perpendicular with the first axis but does not interfere with the movement of the disc transport located on the first slide member. It should be appreciated that the print head further includes a suitable drive means and linkages for movement of the print head along the second slide member. Suitable drive means and linkages may include any of the devices used for movement of the disc transport or any other suitable drive and/or linkage found in the art of disc-publishing devices and more particularly the drive configuration of print heads.

Advantageously, the print heads may be adapted to print to a disc portion located within the print tray. Suitable print heads that can be used with the present invention can be found in the field of inkjet printing. However, printing to a disc using laser or thermal print technology is also within the present invention. In fact, it is contemplated that laser-printing technology may be used to print to a disc, which may include color. Regardless to the print means used, it should be appreciated that the disc-publishing device may print using any of the colors or color combinations found in the print industry.

The print assembly further includes a print tray 28 adapted to receive a disc and provide movement thereabout, which preferably may be substantially perpendicular to the movement of the printer heads. Advantageously, the print tray may be adapted for movement along an axis to effectuate printing. For example, in a preferred embodiment, the print tray may be moveable to a first position, which may be fully extended and a second position, which may be fully retracted. It should be appreciate that during printing, the print tray will move between the first and second position to provide print capability throughout the entire disc located within the print tray. However, upon the step of removing a processed disc from the disc publishing device, the print tray may be configured for incremental movement, which allows for a plurality of intermediate positions for the print tray that are between a “fully extended” position and a “fully retracted” position. It is further appreciated, that the print tray may extend to positions beyond the “fully extended” and “fully retracted” positions, or otherwise.

In a preferred embodiment, the print tray may be configured with a recess having a center adapted to be substantially concentrically aligned with a disc placed therein. Accordingly, in the extended position, the tray may be adapted to receive a disc from the disc transport. For example, it is contemplated that when the disc tray is in a “fully extended” position, the recess portion may be concentrically aligned with the center of the disc portion attached to the disc transport located thereabove. In this respect, the print tray may be positioned so that the center portion of the print tray is in alignment with the engagement mechanism, wherein the disc transport proceeds to place the engaged disc into the print tray. In one configuration, placement of the disc into the print tray comprises lowering the engagement mechanism to the position just above the print tray, releasing the disc into the tray, and raising the engagement mechanism to a first (e.g., original) position. Advantageously, the printer assembly, more specifically, the print tray may include calibration means to align the same with the engagement mechanism, thereabove.

Movement of the print tray can be effectuated using any suitable drive mechanism, and any linkage thereto, adapted for specific positioning of the print tray, which may include reciprocal movement. Suitable drive mechanisms are known in the art of printing and may include stepper motors or otherwise. In a preferred embodiment, to effectuate specific positioning of the print tray, movement of the print tray may be sequenced with the movement and printing of the print head. Preferably, the movement of the print tray and the print head are effectuated through a controller adapted to cause the print tray to move to one or more positions, as discussed herein, so that the one or more print heads can print to a specified region of the disc.

Once processing of the disc is complete, preferably after the printing process, or if there is a disc processing failure, or otherwise, the disc may be removed from the disc publishing device, as mentioned above. By way of one specific example, after processing, the print tray may be extended from the print assembly having a processed disc disposed therein. The print tray extends to a position so as to align the disc located within the recess portion of the print tray with the disc transport located above. Accordingly, the print tray is movable along a generally horizontal axis so as to align the hole of the disc with the engagement mechanism such that the disc hole is generally aligned with the engagement mechanism along the engagement axis. The disc transport moves along the first slide member to at least partially dispose the engagement mechanism within the hole of the processed disc. The engagement fingers engage the processed disc so that the disc may be removed from the print tray therebelow. The disc transport raises the disc along the first slide member and above the movable print tray, wherein the print tray is able to retract without interfering with the engaged disc or the disc transport.

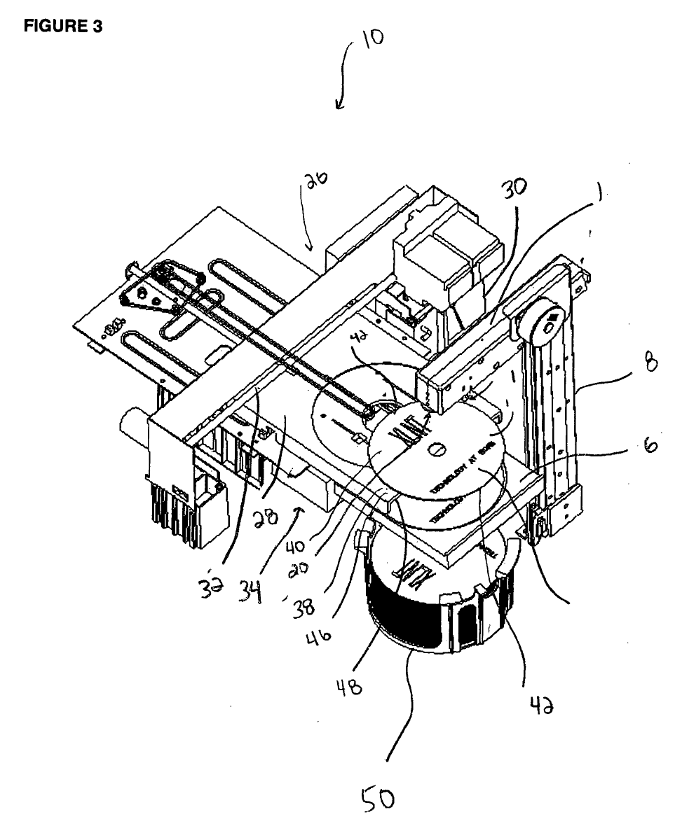

Upon removal of the disc from the print tray, the print tray is at least partially retracted. The disc transport moves the engaged disc towards the partially retracted print tray until a first portion 40 of the disc becomes substantially proximate to or contacts the end portion 46 of the print tray. The engagement mechanism disengages the disc such that the first portion 40 of the disc is positioned on the top surface 38 of the end portion 46. A second portion 44 of the disc is positioned (e.g., suspended) over the outer edge 48 of the end portion 46 such that the second portion is substantially free of contact with the top surface 38 of the print tray, (FIG. 3).

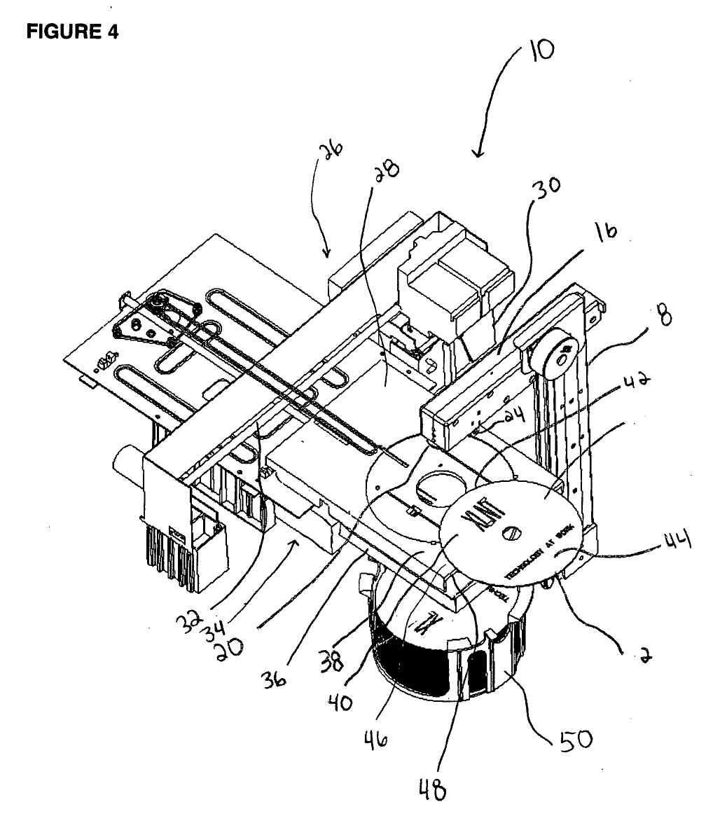

The engagement mechanism is moved upward by the disc transport along the first slide member to clear the disengaged disc that is generally positioned about the outer edge 48 of the print tray. Once the engagement mechanism is completely removed from the inner ring of the disc, the print tray may be fully extended to the “open” position, (FIG. 4), while the disengaged disc remains partially disposed on the top surface of the print tray.

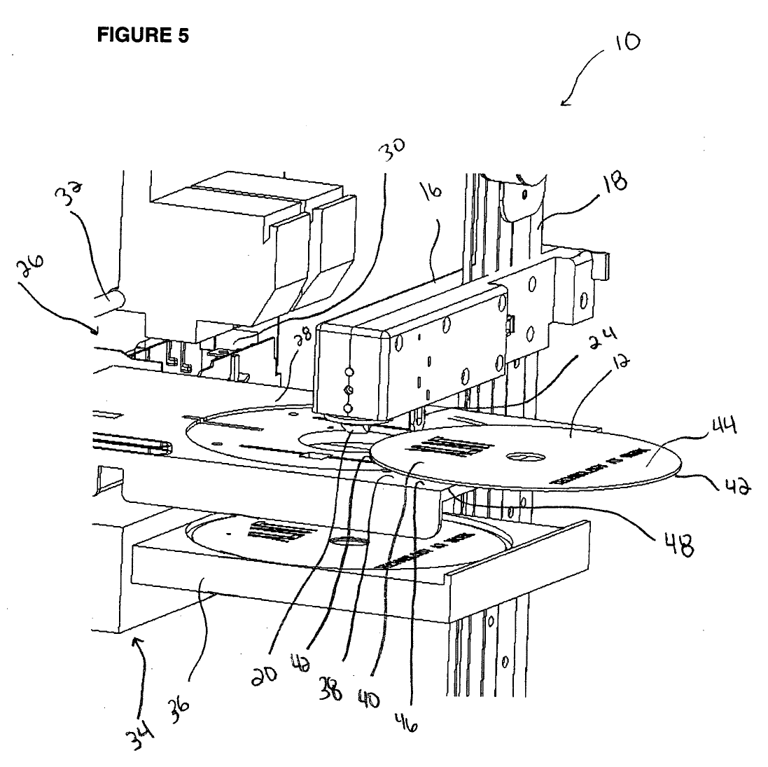

In the print tray's extended position, the disc transport may be lowered so that the disc removal feature contacts or becomes substantially proximate to the top surface of the print tray. Accordingly, the disc removal feature may be positioned adjacent to and behind the outer edge of the first portion of the disc, (FIG. 5). The print tray retracts thereby drawing the outer edge of the first portion of the disc is towards the disc removal feature such that the disc removal feature impedes the disc from further moving with the retracting print tray. The disc remains in the impeded position until the print tray is generally removed from the first portion of the disc, therebelow. As the print tray retracts and is generally removed from beneath the first portion of the disc, the disc drops from the print tray and preferably is deposited into a storage location. Accordingly, it is appreciated that the removal of discs may be accomplished using any media component having similar movable means such as the recording tray or otherwise in association with the disc removal feature of the disc publishing device.

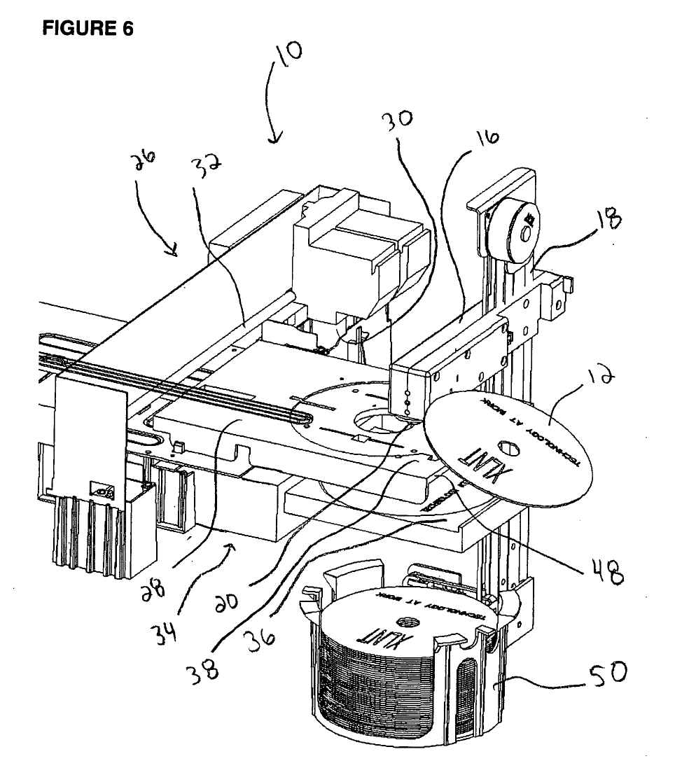

In one embodiment, after the disc removal feature is lowered into position and the print tray is retracting, the disc drops off the print tray edge such that it may be deposited into a storage location that may be preferably positioned outside of the disc publishing device, (FIG. 6). In another embodiment, as the partially disposed disc is extended outward with the print tray, the outer edge 42 of the second portion of the disc may be respectively moved through an opening 54 in the disc publishing device, preferably through a lid 56. The disc removal feature may be lowered into position behind the outer edge of the first portion of the disc such that as the print tray retracts, support by the print tray for the first portion of the disc is decreased so as to allow the disc to be removed (e.g., fall, drop, slide, or otherwise) through the opening in the lid and preferably into a storage location. Optionally, the operator of the disc publishing device may choose not to use the disc removal feature, in this scenario, the operator may physically remove the partially disposed disc from the opening of the lid. The disc publishing device may further include a slide, a catch basket, a storage receptacle, or otherwise. For example, in one embodiment, once the disc is removed (e.g., mechanically or by gravity) from the opening in the lid of the disc publishing device, the disc may be lowered down the slide into a storage receptacle therebelow. The storage receptacle may be removably or fixedly attached to the disc publishing device.

In a preferred embodiment, one or more of the components of the disc-publishing device may be controllable through a controller. For example, in one embodiment, the controller controls the synchronization of movement between the print tray, having a partially disposed disc, and the disc transport for placement of the disc removal feature about the top surface of the print tray. Optionally, the disc publishing device may include sensors that provide feedback to the controller to help determine the positions of the print tray and the disc removal feature, or any other media component with respect to one another for the removal of a disc. Advantageously, the controller may control the movement of the print tray and/or the recording tray for alignment of either tray, while in an extended position, with the engagement mechanism of the disc transport, thereabove.

The controller of the disc-publishing device may be included as a component of the disc-publishing device or alternatively, the controller may be included with a separate component, e.g. not incorporated within the disc-publishing device. However, in a preferred embodiment, the controller may be adapted to receive a signal from a source, such as a computer or otherwise, such that function of the disc-publishing device may be based upon the received signal. Furthermore, preferably the controller causes synchronized operation of the components of the disc-publishing device (e.g., printing, recording, movement of the disc transport or media trays, or otherwise) to maximize print efficiency by minimizing cycle time of any task to be performed.

For example, in one embodiment, it should be appreciated that the disc-publishing device may be communicatively connected to a device adapted to provide information pertaining to desired functions of the disc-publishing device. Suitable devices include processing unit (computers or otherwise) or the like, which preferably provides a user interface for allowing a user to selectively control the functions of the disc-publishing device. Accordingly, the disc-publishing device further includes one or more ports for providing communication between the controller of the disc-publishing device and the user interface, when the controller is an integral part of the disc-publishing device. Suitable communication devices include Universal Serial Bus (USB), parallel port, serial port, BLUETOOTH®, radio frequency, IR, the like or otherwise.

The disc publishing device may include software for communicating with these or other data storage devices. Furthermore, the disc publishing device may include software for performing other disc publishing device functions and/or for communicating with a computer or otherwise.

In one exemplary method, the operation of the disc-publishing device may be demonstrated as follows. A user selects one or more tasks to be performed by the disc-publishing device, via a user interface. As previously mentioned, such tasks may include recording to a disc, printing to a disc, or both. The user interface may be located proximate to the disc-publishing device or remote to the disc-publishing device (e.g., via a network connection, Internet or otherwise). It should also be appreciated that the user interface may comprise an integral component of the disc-publishing device (e.g., located externally or otherwise). Prior to assignment of a task to be performed by the disc-publishing device, the user places one or more discs at the disc supply receptacle.

Through the user Interface, the user selects one or more tasks to be performed to one or more discs. Often, as discussed below, the task includes both the recording and printing of information. For example, the tasks may include transferring data from a source to one or more discs, in a digital format. Also, the tasks may also include printing to the recorded discs, which advantageously corresponds to the information transferred to the disc. Once the tasks have been selected, one or more signals are transferred to the controller of the disc-publishing device to effectuate synchronized operation of the disc-publishing device corresponding to the tasks requested.

For example, in one method of operation, upon transmission of the task signal to the disc-publishing device, the disc transport moves along the first slide member to the disc supply receptacle, located therebelow, wherein the engagement mechanism may be aligned over the holes of the one or more discs located in the disc supply receptacle. The engagement mechanism may be lowered until the flanges, extending from the engagement fingers, become flush with the top disc residing in the disc supply receptacle. The engagement fingers are then separated so that the top disc may be separated from the adjacent disc residing in the disc supply receptacle. The disc transport then raises with the engaged disc to its original position, e.g., above the disc supply receptacle, so as to prevent interference with the receptacle and an extended media tray during transferring of the engaged disc.

The disc may be lowered along the first slide member to the recording device. Preferably, the tray of the recording device may be extended to substantially align the center of the recording tray with the center portion of the disc attached to the engagement mechanism, thereabove. The engagement mechanism may be then lowered proximate to the recording tray and released by moving the engagement fingers together. Upon placement of the disc into the recess formed on the recording tray, the engagement mechanism returns to an original position and the recording tray retracts into the recording device, wherein information may be then recorded onto the disc.

Upon completion of recordation of data to the disc, the recording tray extends and the disc engagement mechanism lowers and once again engages the disc and raises it to the original position. The disc printing tray then moves into an extending position and the recording tray, if necessary, aligns the center of the recess formed in the printing tray with the center of the disc, thereabove. The disc transport then lowers the disc onto the print tray in a similar fashion that was performed with the recording device. The engagement mechanism releases the disc and returns to an upward portion.

The printing tray then moves in synchronization with the print heads of the print assembly to effectuate printing to the surface of the disc. During this process, because of the decoupling of the disc transport and the print assembly, the disc transport moves back to the disc supply receptacle to retrieve another disc and place the disc into the recording device. It should be appreciated that this may be performed during printing to the disc.

Upon completion of the printing to the disc, and advantageously during recordation of data to the disc located in the recording device, the print assembly tray extends to its extended position, thereby aligning the center recess portion with the engagement mechanism, thereabove. The engagement mechanism of the disc transport then engages the completed disc and removes the processed disc from the print tray. The print tray may be partially retracted into the print tray, wherein the engaged disc, thereabove, may be lowered and placed on the top surface of the print tray. The placement of the disc onto the top surface of the print tray partially disposes and supports a first portion of the disc therein, while a second portion of the disc may be suspended over the edge of the print tray.

The disc transport may be then lowered along the first slide member until the disc removal feature contacts a portion of the print tray's top surface, which is proximate to and the first outer edge of the disc's first portion. The print tray then begins to retract while the disc removal feature impedes the movement of the partially disposed disc. As the print tray retracts, the support of the disc's first portion may be reduced, thereby shifting the disc's placement from the print tray. After the disc is displaced from the print tray, it may be subsequently placed in a storage location, or otherwise.

Once the print tray is then fully retracted, the disc transport then moves to the recording device and removes the disc from the recording tray. The disc transport then moves the engaged disc along the first member so as to position the engaged disc for transfer to the print tray, wherein the disc transport then places the engaged disc into the print tray to be printed to. It should be appreciated that this cycle continues until the all of the selected tasks have been completed or the disc from the disc supply receptacle has been exhausted.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only three of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

1. An apparatus for disc publishing comprising:
a disc transport movable along a first slide member, the disc transport including:
an engagement mechanism for selective engagement of at least one disc;
a print assembly for printing to the at least one disc, the print assembly including:
one or more print heads movable along a second slide member; and
a print tray adapted to receive the at least one disc from the disc transport;
a recording device for recording to the at least one disc, the recording device including:
a recording tray adapted to receive and record to the at least one disc from the disc transport;
a disc supply receptacle adapted to receive one or more discs, the disc supply receptacle being positioned below and in alignment along an engagement axis with the engagement mechanism for selective engagement of the at least one disc; and
a control unit adapted to control the functions of the disc publishing device;
wherein the disc transport and the one or more prints heads are adapted to move independent of each other;
wherein the print tray and the recording tray have an open position that is in alignment along the engagement axis for selective engagement of the at least one disc by the engagement mechanism.

2. The apparatus of claim 1, wherein the disc transport generally extends perpendicularly from the first slide member.

3. The apparatus of claim 2, wherein the movable print tray and the movable recording tray are movable in a perpendicular direction to that of the first slide member and the engagement axis.

4. The apparatus of claim 2, wherein the disc transport moves vertically along the first slide member so as to at least partially dispose the engagement mechanism within the hole of the at least one disc along the engagement axis for selective engagement of the at least one disc.

5. The apparatus of claim 1, wherein the disc transport further comprising a disc removal feature for removing discs from the disc publishing device, the disc removal feature includes a down-standing flange located at least approximate to the engagement mechanism, the disc transport, or a combination of both.

6. The apparatus of claim 5, wherein disc removal feature is adapted to impede the movement of a removal disc that is partially disposed on a top surface of either the print tray or the recording tray during retraction thereof so that the removal disc drops off the print tray or the recording tray thereby removing the removal disc from the apparatus.

7. An apparatus for disc publishing comprising:
a disc transport movable along a first slide member in a generally vertical direction, the disc transport including:
an engagement mechanism for selective engagement of at least one disc; and
a disc removal feature;
at least one media component adapted for processing the at least one disc, the media device including:
a movable tray adapted to receive the at least one disc from the disc transport;
a disc supply receptacle adapted to receive one or more discs, the disc supply receptacle being positioned below and in alignment along an engagement axis with the engagement mechanism for selective engagement of the at least one disc; and
a control unit adapted to control the functions of the disc publishing device;
wherein the disc removal feature is adapted to impede the movement of the at least one disc that is partially disposed on a top surface of the movable tray during retraction thereof so that the at least one disc drops off the movable tray thereby removing the at least one disc from the apparatus;
wherein the movable tray has an open position that is in alignment along the engagement axis for selective engagement of the at least one disc by the engagement mechanism.

8. The apparatus of claim 7, wherein the at least one media component is a printer assembly, a recording device, or both.

9. The apparatus of claim 8, wherein the at least one media device further comprises one or more print heads movable along a second slide member and wherein the disc transport and the one or more prints heads are adapted to move independent of each other.

10. The apparatus of claim 7, wherein the disc transport moves vertically along the first slide member so as to at least partially dispose the engagement mechanism within the hole of the at least one disc along the engagement axis for selective engagement of the at least one disc.

11. The apparatus of claim 7, wherein the disc removal feature comprises a down-standing flange located at least approximate to the engagement mechanism.

12. The apparatus of claim 11, wherein the disc removal feature further comprises a sensor for sensing the proximately of the down-standing flange with respect to the top surface of the movable tray.

13. The apparatus of claim 7, further comprising a lid having a slotted opening adapted for receiving the at least one partially disposed disc positioned on the top surface of the print tray.

14. The apparatus of claim 13, further comprising a slide, a storage receptacle, or both, wherein is the slide and the storage receptacle are adapted for receiving the at least one disc.

15. A method for removing a storage disc comprising the steps of:
providing a disc publishing device comprising:
a disc transport including:
an engagement mechanism; and
a disc removing feature;
at least one of a printer assembly and a recording device including:
a movable tray having a top surface and a tray edge;
a disc supply receptacle adapted to receive one or more discs, the disc supply receptacle being positioned in alignment with and below the engagement mechanism of the disc transport;
partially extending the movable tray thereby positioning the tray edge in general alignment with a disc to be removed and the engagement mechanism thereabove;
disengaging the disc to be removed onto the partially extended movable tray, wherein the disc to be removed is partially disposed on the top surface of the print tray;
raising the disc transport along a first slide member in an engagement axis to clear the engagement mechanism from the disengaged disc to be removed;
fully extending the movable tray thereby positioning the disc removal feature above and in general alignment behind a disc edge of a first portion of the disc to be removed positioned on the top surface of the movable tray;
lowering the disc transport along the first slide member and placing the disc removal feature generally proximate to and behind the disc edge of the first portion of the disc to be removed; and
retracting the movable tray while the disc removal feature impedes the disc to be removed from retracting with the movable tray; and
removing the disc to be removed from the disc publishing device.

16. The method of claim 15, further comprising the step of providing a lid having a slotted opening.

17. The method of claim 16, wherein the step of fully extending the movable tray further comprises disposing the disc edge of a second portion of the disc to be removed through the slotted opening of the lid.

18. The method of claim 17, wherein the step of removing the disc to be removed includes a user removes the disc to be removed that is partially disposed through the slotted opening of the lid

19. The method of claim 15, further comprising the step of providing at least one of a slide, a storage receptacle, or both located adjacent to the movable tray.

20. The method of claim 19, wherein the step of removing the disc includes at least one of:
i. the processed disc slides down the slide into the storage receptacle; and
ii. the processed disc drops into the storage receptacle.
